(19) United States
(12) Patent Application Publication
(10) Pub. No.: US 2019/0000127 A1
(43) Pub. Date: Jan. 3, 2019

(54) HIGH-PROTEIN COMPOSITIONS AND METHODS OF THEIR MAKING AND USE

(71) Applicant: INTERNATIONAL DEHYDRATED FOODS, INC., Springfield, MO (US)

(72) Inventors: Stephanie LYNCH, Springfield, MO (US); Roger L. DAKE, Springfield, MO (US); Jack C. CAPPOZZO, Springfield, MO (US); David HAWK, Cave Creek, AZ (US)

(21) Appl. No.: 16/024,186

(22) Filed: Jun. 29, 2018

Related U.S. Application Data
(60) Provisional application No. 62/526,481, filed on Jun. 29, 2017.

(51) Int. Cl. A23L 33/175; A23J 3/04; A23L 19/00; A23L 7/126

(52) U.S. Cl. CPC A23L 33/175; A23J 3/04; A23V 2002/00; A23L 7/126; A23L 19/05

(57) ABSTRACT

The disclosure provides protein particles (or crisps) that may be used to enhance the protein content of snack products or other food products or as nutritional or dietary supplements. Methods for making the protein particles and for making high-protein, low-fat and low-sodium snack food compositions are also disclosed.

### RELATED APPLICATIONS

This application claims priority to U.S. Provisional Application No. 62/526,481 filed Jun. 29, 2017, the entire content of which is hereby incorporated by reference into this application.

### BACKGROUND

### 1. Field of Invention

This disclosure relates to a composition that may be used as a nutritional or dietary supplement to increase daily protein intake.

### 2. Description of Related Art

Snack food such as snack bars currently on the market typically have low protein but high carbohydrates. Some snack bars may have added protein to increase their overall protein content. However, these snack bars tend to have relatively high level of sodium and/or fat. Also, the added proteins in some snack products are allergenic.

### SUMMARY

The compositions disclosed herein may be used as a nutritional or dietary supplement to increase daily protein intake, while avoiding the high sodium and high fat that are typical of most snacks on the market.

In one embodiment, the disclosure provides a composition that may be used to enhance the protein content of snack products or other food products or as nutritional or dietary supplements. In another embodiment, a method for making a high-protein, low-fat and low-sodium snack food is disclosed. Examples of snack food may include but are not limited to snack bar, granola bar, or granola mix.

In one embodiment, the high quality protein is delivered in the form of a plurality of protein particles (also referred to as “crisp” or “protein crisp” in this disclosure), which may contain one or more essential amino acids, for maintaining health and providing muscle recovery and growth for an active individual, such as athletes or children. In one aspect, the plurality of protein particles may contain L-Arginine which is a precursor for the production of nitric oxide (NO) via nitric oxide synthase (NOS) that stimulates vasodilatation which, in turn, enhances blood and oxygen supply to the muscle for muscle recovery in an athletic or active individual. In another aspect, the protein crisps may also provide necessary proteins for the elderly for maintaining muscle mass.

In one embodiment, the present disclosure provides a snack composition in a unique format that delivers high quality protein with minimal fat or with no fat. In one aspect, the protein crisps contain high concentration of protein but minimal fat, for example, less than 5%, less than 1%, less than 0.5%, or less than 0.1% of fat, or with no fat (i.e., 0% within the normal limit of detection).

In another aspect, the disclosed protein crisps may contain much lower sodium concentration as compared to other protein supplement. For example, the sodium concentration in the plurality of protein particles may be at 50 mg or lower, 25 mg or lower, or 10 mg or lower, per 100 grams of crisps. A typical egg protein preparation on the market usually contains about 100 mg sodium per 100 grams of protein preparation. Low sodium diet is required for individuals with certain health conditions.

In another embodiment, the snack composition of this disclosure may be used as a nutritional or dietary supplement to increase protein intake in daily diet. In one aspect, the disclosed protein crisps may be prepared from a protein source selected from animal, plant, insect and combination thereof. In another aspect, the disclosed protein crisps may be prepared from poultry and are non-allergenic as described in FALCPA (Food Allergen Labeling and Consumer Protection Act of 2004, Public Law 108-282, Title II). In another aspect, the protein crisps contains low net carbohydrate, low lipids (fats) and low in sodium. By way of example, the disclosed composition may have a carbohydrate concentration in the range of 0.1-15%, 0.1-10%, or 0.1-5%.

In one embodiment, the current process uses the high protein preparation disclosed in PCT application PCT/US17/14473, or in U.S. Patent application Ser. Nos. 14/325,694; 14/698,150; 14/698,274 or 14/698,332 and forms the plurality of protein particles (also called protein crisps). The protein crisps may be added to a traditional snack bar or snack mixture.

Examples of the different forms of the protein crisps may include extruded particles of chicken protein of a certain size to form a snack bar or for producing a snack mixture that has a certain and desired texture. In one aspect, the disclosed protein crisps contain excellent source of high-quality protein but do not contain significant amount of carbohydrates and/or lipids (fat). In another aspect, the disclosed protein crisps contain excellent source of high-quality protein but do not contain any carbohydrates or any lipids (fat).

In one embodiment, the compositions made by the disclosed process may contain many traditional ingredients of a snack bar. In one aspect, the high-protein crisps increases the protein content of the composition. In another aspect, the high-protein crisps may provide unique taste and/or texture to the final product. In another aspect this high-protein crisp can be dietary supplement to increase, maintain, or enhance dietary protein in a person required daily allowance or intake or add more protein to greater metabolic requirements.

In one embodiment, the compositions made by the disclosed process may have higher protein content than a traditional snack bar or other food products while maintaining the same, similar or better taste and texture characteristics as compared to traditional snack bars or food products without the added high-protein crisps. In another embodiment, the compositions made by the disclosed process may have much higher protein:sodium ratio, protein:fat ratio and/or protein:carbohydrate ratio as compared to traditional snack bars or food products without the added high-protein crisps.

In one aspect, the ratio between proteins and fat in the crisps is at least 50:1, or at least 100:1, or at least 500:1. In another aspect, the ratio between proteins and carbohydrate in the crisps is at least 50:1, or 100:1, or at least 500:1. In another aspect, the protein crisps do not contain any carbohydrate or fat. The disclosed composition contain at least two parts: snack food component and the protein crisp component. The protein crisp enhance the protein content of the composition, but the snack food component may add to the higher content of sodium, fat and/or carbohydrate. In one aspect, the disclosed composition have a protein:sodium ratio (w/w) higher than 500, 1000, or 2000. In another aspect, the disclosed composition have a protein:fat ratio (w/w) higher than 20, 50, 80, or 100. In another aspect, the disclosed composition have a protein:carbohydrate ratio (w/w) higher than 10, 20, 50, 80, or 100. In another embodiment, the high-protein crisps contribute to the unique form and texture of the snack bar or snack food.

In another embodiment, the high-protein crisps may be made from poultry parts or other animal parts.

In another embodiment, the high-protein crisps may be formed to a certain size and texture. In one aspect, the protein concentration of the crisps may be in the range of 20-100% (by weight). In another aspect, the protein concentration of the crisps may be at least 30%, 40%, 50%, 60%, 70%, 80%, at least 90%, or 100% (by weight). In another embodiment, the protein crisps may be formed with additional ingredients, such as starch and water. In another embodiment, the protein crisps may be mixed with these additional ingredients and be extruded into pieces with a desired texture or baked to a certain size and texture. Particle size of the crisps may range from 0.5 mm to 12 mm, from 1 mm to 12 mm, from 2 mm to 10 mm, or from 4 mm to 8 mm. The crisps may be made into various shapes such as spherical, tubular, cubical or other geometrical forms. When the measurements of different dimensions of the crisps are different, the term “particle size” refers to the average of the different dimensions, for example, when they are in a tubular (rectangular) form, “particle size” refers to the average of the length, width and depth.

For purpose of this disclosure, percentage concentration is expressed as w/w unless otherwise indicated.

These high-protein particles (crisps) may have a varied texture based on the different concentrations of the different components. In one embodiment, fiber and water can be added to provide a chewy texture, among other functions. In another embodiment, starch and water can be added for a harder and crunchier texture, among other functions. In one aspect, the fiber may be a complex non-digestible carbohydrate of longer than 3 carbon units.

In another embodiment, formed particles may be added to the snack bar formula with other components to bind the protein particle with other ingredients such as nuts, dehydrated fruit, syrup binders and other such items. The bars can be formed into bar shapes and cooked or dried to a finished state. Formed particles can be formed into unique versions of traditional items such as a granola bar or can be mixed with granola items, nuts, dried fruit, candy and other such items for a lose granola mixture.

In another embodiment, the high-protein crisps are made from poultry, which includes chicken, turkey, duck among other poultry species. The poultry crisps contain high protein but minimal amount of fat.

In another embodiment, the protein crisps may be the sole protein source of food snacks or in combination with other sources of protein in various forms. In one aspect, the protein crisps can be added to increase protein content in the snack composition by at least 1%, 10%, 30%, 50%, 70%, or at least 99%. In another aspect, the final protein content in the snack composition is at least 1%, 2%, 10%, 30%, 50%, 70%, at least 90%, or 99% (w/w). Other forms of protein may include nuts and other concentrated protein powders such as milk (casein and/or whey), pea protein, and other various plant, insect and other animal proteins.

In one embodiment, the poultry protein crisps may contain one or more peptides having 10 or fewer amino acids. In another embodiment, the protein crisps may contain one or more amino acids selected from the group consisting of arginine, lysine, methionine, leucine, isoleucine, valine and combination thereof. In another embodiment, the protein crisps may contain one or more branched chain amino acids, and the content of these branched chain amino acids in the protein mix is higher than content of branched chain amino acids in the comfort food before the protein mix is added.

In certain embodiments, the poultry protein crisps may be prepared from poultry powder or broth that are prepared according to methods described in U.S. patent application Ser. Nos. 14/325,694; 14/698,150; 14/698,274 and 14/698,332, which are hereby incorporated into this application by reference.

### DETAILED DESCRIPTION

A “snack food” is used to generally describe a number of traditional food items that typically have high levels of carbohydrate and calorie but relatively lower protein content. Examples of snack food may include but are not limited to a chocolate candy bar, hard candy, granola and granola bars, potato chips or crisps, crackers, cheese, peanuts, mixed nuts, popcorn, cake, fruit and cream pies, ice cream and ice cream novelties, meat jerky, sausage snacks and many others. The proteins crisps may also be added to nutritional supplement of a snack food or snack bar or nutritional snack food or nutritional supplement. Many snacks, tend to have a relatively high carbohydrate and/or fat load and are therefore viewed as less healthy or unhealthy. Nuts and cheese typically have higher protein content and are viewed as a healthy alternative. However, they usually contain an allergen and cannot be consumed by people with food allergy.

The present disclosure provides protein crisps having enhanced protein content. The crisps are prepared from animal or plant sources and are shaped into certain geometrical forms that have larger particle size than powder. The term “protein crisps” refers to such high-protein preparation that is shaped into various forms, and may be referred to as high-protein crisps, protein chips, or particles, etc.

In one embodiment, the protein crisps may be added to a traditional snack food in a form of a particle of formed shape that contains high protein content or composition. The particle of high protein content or composition is added to a food to obtain an improved composition having higher protein content. A particle of high protein poultry can be formed as a baked, extruded or thermally processed particle to a size and texture to incorporate as the main ingredient or ingredient component in a snack food. In one embodiment, the protein mix is enriched in a poultry protein, such as chicken. In another embodiment, the protein mix is a dehydrated high protein powder or broth prepared from natural meat, such as poultry and the powder is formed into a particle.

The protein crisps can be formed into desired texture, size and shapes dependent on the snack food. In one embodiment, small round particles of 4 mm can be form and mixed with an adhesive syrup and form a bar shape of 100 mm length by 20 mm wide and 5 mm in depth and either heat treated (cooked) or dried to a final consistency. The texture can be dependent on either the moisture content of the form particle of protein content or composition or in the snack food formula to produce soft and chewy to crunchy.

In one embodiment, the protein crisps can be made from dehydrated meat powder or they may be prepared from poultry meat, meat on bones, or bones in a mechanical meat separation process. The meat and/or bone may be cooked in slurry and the fraction of fat is removed and the solid protein is collected as well as the water or broth fraction. The protein and broth fractions may be collected and dried by different process methods. Examples of drying process methods may include but are not limited to air drying, spray drying or other methods known in the art.

In another embodiment, the protein crisps may be derived from a rendering process.

In one aspect, the protein crisps may contain hydrolyzed protein. In another aspect, the protein crisps may be prepared from acidic or enzymatic treatment. This protein crisps may have an enhanced functionality, which may include, for example, particle size, texture, solubility, ingredient bind, water holding, flavor or other chemical and physical properties. In another aspect, the protein crisps may contain higher content of branched chain amino acids. In another aspect, poultry protein crisps may contain essential amino acids such as L-Arginine.

In another embodiment, peptides, derivative amino acids and metabolite constituents or compounds may be added to the protein crisps. Examples of such peptides, derivative amino acids and metabolite constituents or compounds may include but are not limited to creatine, creatinine, camosine, taurine, L-camitine and anserine.

By way of example, a number of embodiments of the present disclosure are listed below:
Item 1—A composition comprising a snack food and a plurality of protein particles, wherein the composition has higher protein content than protein content of said snack food, said protein particles contributing to the higher protein content of said composition, wherein the smallest dimension of the plurality of protein particles is at least 0.5 mm.
Item 2—The composition of Item 1, wherein the plurality of protein particles are in a geometrical shape selected from the group consisting of round, oval, square, rectangular and polygonal shapes.
Item 3. The composition of any of the preceding Items, wherein the plurality of protein particles are made into a rectangular shape and wherein the length and width of the rectangular shape are each greater than 1 mm.
Item 4. The composition of any of the preceding Items, wherein proteins from the plurality of protein particles contribute to from about 50% to 100% of the total protein content of said composition.
Item 5. The composition of any of the preceding Items, wherein proteins from the plurality of protein particles contribute to from about 75% to 100% of the total protein content of said composition.
Item 6. The composition of any of the preceding Items, wherein the plurality of protein particles are prepared from a protein source selected from animal, plant, insect and combination thereof.
Item 7. The composition of any of the preceding Items, wherein the plurality of protein particles are prepared from poultry.
Item 8. The composition of any of the preceding Items, wherein the snack food is selected from the group consisting of a snack bar, a protein bar, a granola bar, a snack mix, a trail mix and combination thereof.
Item 9. The composition of any of the preceding Items, wherein the snack food is in the shape of a bar and the plurality of protein particles are physically attached to the bar.
Item 10. The composition of any of the preceding Items, wherein the plurality of protein particles are subject to a process selected from the group consisting of baking, extrusion, thermal processing, and combination thereof before being added into said composition.
Item 11. The composition of any of the preceding Items, wherein the plurality of protein particles are not subject to any thermal or chemical processing before being added to the snack food.
Item 12. The composition of any of the preceding Items, wherein the plurality of protein particles are in a loose mix with the snack food but not physically attached to the snack food.
Item 13. The composition of any of the preceding Items, wherein the plurality of protein particles comprise one or more peptides having 10 amino acids or fewer.
Item 14. The composition of any of the preceding Items, wherein the plurality of protein particles comprise one or more branched chain amino acids.
Item 15. The composition of any of the preceding Items, wherein the plurality of protein particles comprise one or more amino acids selected from the group consisting of arginine, lysine, methionine, leucine, isoleucine, valine and combination thereof.
Item 16. The composition of any of the preceding Items, wherein the plurality of protein particles comprise L-Arginine.
Item 17. The composition of any of the preceding Items, wherein the plurality of protein particles have a water activity (a_{w}) of less than 0.80, less than 0.85 or less than 0.90.
Item 18. The composition of any of the preceding Items, wherein the composition has carbohydrate concentration of from 0-5%.
Item 19. The composition of any of the preceding Items, wherein the composition further comprise greater than 1%, 2%, 4%, or 5% (w/w) fiber.
Item 20. A composition comprising a plurality of protein particles, wherein the plurality of protein particles have higher than 30%, 50%, 70%, or 80% protein content and are in a geometrical shape selected from the group consisting of round, oval, square, rectangular and polygonal shapes, wherein the smallest dimension of the plurality of protein particles is at least 0.5 mm.

### EXAMPLES

### Example 1: Blueberry Nut Bar

Extruded poultry protein pieces (crisps) were formed on an extruder with a formula of 32.45% chicken powder, 26.55% pea protein powder, 24.50% long grain rice flour, 15.00% Fiber-Litesse, 1.00% salt, and 0.50% CaCO₃. Extruded pieces were ¼″ long by ⅛″ wide by 1/16″ depth.

19.10% protein crisps, 17.80% High Maltose Corn Syrup, 12.90% Almonds-Raw, 12% Dried Blueberries, 10% Roasted Salted Pumpkin Seeds, 8.01% Sunflower Butter, 6.05% Invert Sugar, 1.07% Canola Oil, 0.71% Glycerin, and 0.36% Lecithin were combined, mixed to form a bar shape of 4″ by 1½′ by ½′. The bar was thermally heat treated at 160° F. until an internal temperature of 140° F. was reached and an a, of 0.80 was achieved.

### Example 2: High Protein Granola

A mix of 38% Protein Crisps of Example 1, 24% Rolled Oats, 12% Almonds, 8% Organic Brown Rice Syrup, 6% peanuts, 5% chocolate Chunks, 4% Pumpkin Seeds, 1.5% Maple Syrup, 1.5% Honey was prepared.

The mix was heat treated at 250° F. for 35 minutes and cooled to room temperature. Tumble to loosen all pieces. Add chocolate chunks and pumpkin seeds and tumble to mix. Water activity (a_{w}) should be less than 0.85. Package the material.

### Example 3: High Protein Granola Bar

A mix of 38% Protein Crisps of Example 1, 22% Rolled Oats, 10% Almonds, 10% Organic Brown Rice Syrup, 4% peanuts, 5% chocolate Chunks (high melt chocolate), 4% Pumpkin Seeds, 3.5% Honey, 3.0% Maple Syrup, 0.5% Lecithin was prepared.

The mix was heat treated at 250° F. for 35 minutes and cooled to room temperature. Tumble to loosen all pieces. Add Organic Rice Syrup, lecithin, chocolate chunks and tumble to mix. Form into bars by extrusion or molds and thermally treat 160° F. for 30 minutes. Water activity (a_{w}) should be less than 0.85. Allow to cool and package.

### Example 4: Citrus Bar

A mix of 19.10% Protein Crisps of Example 1, 17.80% High Maltose Corn Syrup, 12.90% dehydrated pineapple, 6% Dried Apricots, 10% Roasted Salted Pumpkin Seeds, 8.01% Sunflower Butter, 6.05% Invert Sugar, 1.07% Canola Oil, 0.71% Glycerin, and 0.36% Lecithin was prepared. The mix was formed to a bar shape of 4″ by 1½′ by ½′ and was thermally heat treated at 160° F. until an internal temperature of 140° F. was reached and an a_{w} of 0.80 was achieved.

### Example 5 Snack Food with Chicken Protein Pieces

Protein mix containing chicken protein was added to snack mix or snack bars. The protein mix contains chicken protein in the form of crunchy extruded protein chip, cracker or cereal piece and helped achieve 1% or higher protein content in the final product. The snack mix was selected from a wide variety of snack food and may contain nuts, dehydrated fruit or vegetable pieces, popcorn, and other extruded chips, cereals, or grain pieces and may have an added flavor mix, such as barbeque or cinnamon.

### Example 6 Snack Food with Chicken Protein Pieces

Protein mix containing chicken protein was added to snack mix or snack bars. The protein mix contains chicken protein in the form of crunchy extruded protein chip, cracker or cereal piece and helped achieve 1% or higher protein content in the final product. The snack mix was selected from a wide variety of snack food and may contain nuts, dehydrated fruit or vegetable pieces, popcorn, and other extruded chips, cereals, or grain pieces, but did not contain any ingredients that may cause food allergy (e.g., peanut, gluten, etc.) in humans. The snack food may also contain an added flavor mix, such as barbeque or cinnamon.

We claim:

1. A composition comprising a snack food and a plurality of protein particles, wherein the composition has higher protein content than protein content of said snack food, said protein particles contributing to the higher protein content of said composition, wherein the smallest dimension of the plurality of protein particles is at least 0.5 mm.

2. The composition of claim 1, wherein the plurality of protein particles are in a geometrical shape selected from the group consisting of round, oval, square, rectangular and polygonal shapes.

3. The composition of claim 1, wherein the plurality of protein particles are made into a rectangular shape and wherein the length and width of the rectangular shape are each greater than 1 mm.

4. The composition of claim 1, wherein proteins from the plurality of protein particles contribute to from about 75% to 100% of the total protein content of said composition.

5. The composition of claim 1, wherein the plurality of protein particles are prepared from a protein source selected from animal, plant, insect and combination thereof.

6. The composition of claim 1, wherein the plurality of protein particles are prepared from poultry.

7. The composition of claim 1, wherein the snack food is selected from the group consisting of a snack bar, a protein bar, a granola bar, a snack mix, a trail mix and combination thereof.

8. The composition of claim 1, wherein the snack food is in the shape of a bar and the plurality of protein particles are physically attached to the bar.

9. The composition of claim 1, wherein the plurality of protein particles are subject to a process selected from the group consisting of baking, extrusion, thermal processing, and combination thereof before being added into said composition.

10. The composition of claim 1, wherein the plurality of protein particles are not subject to any thermal or chemical processing before being added to the snack food.

11. The composition of claim 1, wherein the plurality of protein particles are in a loose mix with the snack food but not physically attached to the snack food.

12. The composition of claim 1, wherein the plurality of protein particles comprise one or more peptides having 10 amino acids or fewer.

13. The composition of claim 1, wherein the plurality of protein particles comprise one or more branched chain amino acids.

14. The composition of claim 1, wherein the plurality of protein particles comprise one or more amino acids selected from the group consisting of arginine, lysine, methionine, leucine, isoleucine, valine and combination thereof.

15. The composition of claim 1, wherein the plurality of protein particles comprise L-Arginine.

16. The composition of claim 1, wherein the plurality of protein particles have a water activity (a_{w}) of less than 0.85.

17. The composition of claim 1, wherein the composition has carbohydrate concentration of from 0-5%.

18. The composition of claim 1, wherein the composition further comprise greater than 1% fiber.

19. A composition comprising a plurality of protein particles, wherein the plurality of protein particles have higher than 30% protein content and are in a geometrical shape selected from the group consisting of round, oval, square, rectangular and polygonal shapes, wherein the smallest dimension of the plurality of protein particles is at least 0.5 mm.

20. A method of making the composition of claim 1.
